(19) United States
(12) Patent Application Publication
(10) Pub. No.: US 2026/0052022 A1
(43) Pub. Date: Feb. 19, 2026

(54) Self-Expanding Symbolic Intelligence System (SESIS)

(71) Applicant: KJuan Rivera, Buffalo, NY (US)

(72) Inventor: KJuan Rivera, Buffalo, NY (US)

(21) Appl. No.: 19/260,612

(22) Filed: Jul. 7, 2025

(51) Int. Cl. H04L 9/32

(52) U.S. Cl. CPC H04L 9/3239

(57) ABSTRACT

A recursive symbolic intelligence system is disclosed that employs continuously evolving symbolic nodes represented as multi-dimensional vectors with physical, cultural, and optionally functional sub-components. The system implements a mathematically defined recursive update function s(i)(t+1)=α·s(i)(t)+β·f(adj)({s(j)(t)})+γ·f(input)(v(i)), wherein α, β, and γ are tunable weighting factors; f(adj), aggregates contributions from semantically and topologically adjacent nodes; and f(input), processes incoming multi-modal input including text, audio, video, and sensor data. A tamper-evident ledger configured with a cryptographic hashing function such as SHA-256 records each symbolic update, and a scheduling module employing a multi-armed bandit algorithm together with a meta-learning engine utilizing covariance matrix adaptation evolution strategy dynamically optimizes processing resources and hyper-parameters. This system provides a continuous, adaptive, and auditable framework for dynamic knowledge representation applicable to domains such as autonomous systems, adaptive content generation, and symbolic legacy encoding.

### BACKGROUND

The present invention relates to artificial intelligence and knowledge representation. More specifically, it pertains to a dynamic, recursive, and auditable symbolic system that continuously refines its internal representations using mathematically rigorous update rules to integrate multi-modal data.

A recursive symbolic intelligence system is disclosed that employs continuously evolving internal representations to integrate multi modal data. Contemporary artificial intelligence systems rely either on opaque deep neural networks or on static symbolic methods that lack continuous adaptability. Hybrid approaches exist but do not provide the continuous evolution and verifiable record keeping required for adaptive applications. A system that integrates mathematically defined recursive updates with an immutable cryptographic audit trail is therefore desirable.

### SUMMARY

The guiding vision of the present invention is:

“Free-form intelligence, unchained, unbounded, expanding in growth, defining reality using its own symbols.”

In one embodiment, SESIS realizes this vision by autonomously generating, validating, and evolving its symbol set in a continuous, self-tuning loop. No external ontology governs its symbol-universe: instead, each symbol emerges from raw data and collectively defines the system's internal representation of reality.

The Self-Expanding Symbolic Intelligence System (SESIS) provides a continuously adaptive framework in which symbolic nodes—represented as multi-dimensional vectors comprising physical, cultural, and optionally functional sub vectors—are updated in real time by a recursive update engine. SESIS receives multi modal input, including text, audio, video, and sensor data, via dedicated ingestion adapters that extract salient features and convert them into a standardized symbolic format. The recursive update engine employs the equation s(i)(t+1)=α·s(i)(t)+β·f(adj)({s(j)(t)})+γ·f(input)(v(i)), where α, β, and γ are tunable weighting factors, f(adj) aggregates contributions from semantically and topologically adjacent nodes, and f(input) processes incoming input for node i. A tamper-evident ledger, implemented with cryptographic functions such as SHA-256, records each update, while a scheduling module based on multi-armed bandit algorithms dynamically allocates processing resources based on a novelty-to-reliability ratio. Additionally, a meta-learning engine employing the covariance matrix adaptation evolution strategy (CMA-ES) optimizes hyper parameters such as α, β, and a preset novelty threshold. Alternative embodiments provide for non-linear update functions, advanced graph-based aggregation methods, distributed ledger implementations, and hardware acceleration.

### BRIEF DESCRIPTION OF THE DRAWINGS

FIG. 1—System Architecture:

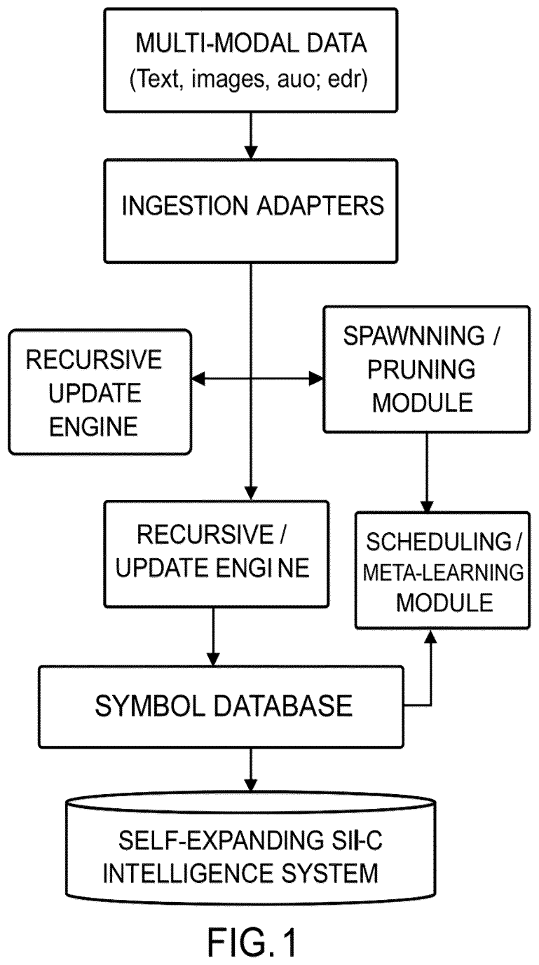

A schematic block diagram depicting the overall architecture of SESIS, including modules for multi-modal data ingestion, graph-based symbolic storage, the recursive update engine, the cryptographic ledger, node spawning/pruning mechanisms, a multi-armed bandit scheduling module, the CMA-ES meta-learning engine, and interfacing components.

FIG. 2—Recursive Update Flowchart:

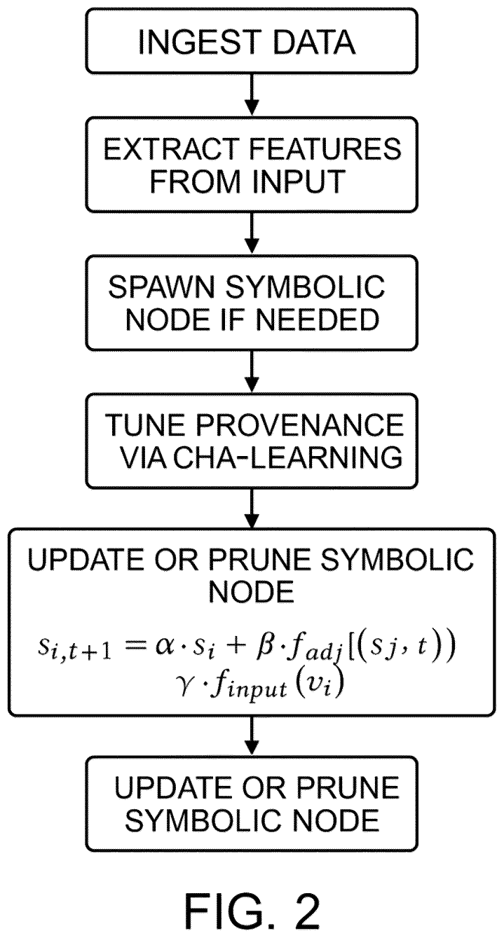

A detailed flowchart illustrating the step-by-step process by which a symbolic node is updated. The flowchart highlights stages for data ingestion, feature extraction, application of the recursive update function (with the embedded equation), and logging of each update via cryptographic hashing.

### DETAILED DESCRIPTION

SESIS is designed to continuously evolve its internal knowledge representation through several key components. The system receives multi-modal data—including text, images, audio, video, and sensor signals—via dedicated ingestion adapters that extract salient features and convert diverse inputs into a standardized symbolic format. Each symbolic node is stored in a graph database to preserve both topological relationships and semantic proximity, and is represented as a multi-dimensional vector subdivided into a physical sub-vector (capturing sensory and measurable attributes), a cultural sub-vector (capturing contextual and semantic associations), and optionally a functional sub-vector (representing operational parameters). The core recursive update engine refines each node continuously using the formula s(i)(t+1)=α·s(i)(t)+β·f(adj)({s(j)(t)})+γ·f(input)(v(i)), where the weighting factors α, β, and γ are adjustable and where f(adj) aggregates inputs from adjacent nodes while f(input), processes new multi-modal input. Novel data elements can trigger the spawning of new nodes or the pruning of redundant nodes based on a novelty scoring function. Every update is immutably recorded in a tamper-evident ledger by computing a cryptographic hash as hash=SHA256 (prev_hash/timestamp/source_id/feature_snapshot), where “/” denotes concatenation. SESIS further includes a scheduling module employing a multi-armed bandit algorithm for dynamic resource allocation, and a meta-learning engine utilizing CMA-ES to optimize hyper-parameters based on performance metrics. Alternative embodiments describe the use of different cryptographic algorithms such as SHA-3, non-linear update functions using activation functions (e.g., sigmoid, tanh, or ReLU), graph neural network techniques for enhanced aggregation, distributed ledger networks for increased security and redundancy, and specialized hardware such as FPGAs or ASICs for acceleration.

### Alternative Embodiments

a. Alternative Cryptographic Implementation:

In alternative embodiments, the tamper-evident ledger may deploy other secure hashing algorithms (e.g., SHA-3 or BLAKE2) or digital signature methods, thereby adapting to future security standards while preserving audit-ability.

b. Non-Linear Update Function:

An alternative to the linear update is to incorporate a non-linear activation function. For example, the update function may be modified to:

$${s}_{i} ( t + 1 ) = φ ( α \cdot {s}_{i} ( t ) + β \cdot {f}_{( adj )} ( \{ s □ ( t ) \} ) + γ \cdot {f}_{( input )} ( {v}_{i} ) + δ ) ,$$

where φ is a non-linear activation function (e.g., sigmoid, tanh, or ReLU) and δ represents a bias term.
   c. Alternative Aggregation Methods:

The aggregation function f(adj({s□(t)}) may be implemented using graph neural network architectures such as graph convolutional or graph attention networks, thereby enhancing the capacity to model complex relational dependencies.

d. Distributed Implementation:

SESIS may be fully implemented on a cloud or distributed computing platform, enhancing scalability and providing elastic computing resources for large-scale, real-time data processing.

e. Hardware Acceleration:

In further embodiments, the recursive update engine and associated processing modules could be implemented on specialized hardware such as FPGAs or ASICs, yielding improved performance and energy efficiency.

1. A system for recursive symbolic intelligence, the system comprising:
a plurality of symbolic nodes, each represented as a multi-dimensional sub-vector comprising at least a physical sub-vector encoding sensory and measurable attributes, and a cultural sub-vector encoding contextual and semantic associations;
a recursive update engine configured to update each symbolic node from time t to time t+1 according to the symbolic update function s(i)(t+1)=α·s(i)(t)+β·f(adj)({s(j)(t)})+γ·f(input)(v(i)), wherein α, β, and γ are tunable weighting factors, f(adj) is a function aggregating semantically and topologically adjacent nodes, and f(input) is a function transforming multi-modal input vectors;
and a tamper-evident ledger configured to record each symbolic update by computing and storing a cryptographic hash.

2. The system of claim 1, wherein each symbolic node further comprises one or more additional sub-vectors selected from the group consisting of: functional, ethical, temporal, affective, or other contextually derived dimensions.

3. The system of claim 1, wherein the tamper-evident ledger employs the SHA-256 cryptographic hashing function such that hash=SHA256 (prev_hash/timestamp/source_id/feature_snapshot), wherein “/” denotes concatenation.

4. The system of claim 1, further comprising a scheduling module that utilizes a multi-armed bandit algorithm to allocate processing resources to incoming data streams based on a calculated novelty-to-reliability ratio.

5. The system of claim 1, further comprising a meta-learning engine employing covariance matrix adaptation evolution strategy to dynamically adjust at least one hyper-parameter selected from the group consisting of α, β, and a predefined novelty threshold based on real-time performance metrics.

6. The system of claim 1, further comprising a distributed ledger network in which the tamper-evident ledger is implemented across a plurality of decentralized nodes to enhance security and redundancy of recorded updates.

7. The system of claim 1, further comprising a non-linear transformation module integrated within the recursive update engine wherein one or more non-linear activation functions are applied to the symbolic node state prior to updating.

8. The system of claim 1, further comprising an alternative meta-learning engine that utilizes a reinforcement learning-based optimizer, either in lieu of or in combination with the covariance matrix adaptation evolution strategy, to dynamically adjust the weighting parameters and the novelty threshold in real time.

9. The system of claim 1, wherein the function f(adj)({s(j)(t)}) is implemented using a graph convolutional network or a graph attention network to aggregate and weight contributions from semantically or topologically related symbolic nodes.

10. The system of claim 1, further comprising a memory buffering subsystem that aggregates historical states of a symbolic node over multiple time steps, thereby providing enhanced contextual information for the recursive update engine and improving convergence characteristics.
